(19) United States
(12) Patent Application Publication
(10) Pub. No.: US 2024/0076241 A1
(43) Pub. Date: Mar. 7, 2024

(54) METHODS FOR CONTINUOUS PRODUCTION OF SULFUR POLYMER CEMENT

(71) Applicant: Outside the Box Materials, LLC, Elmhurst, IL (US)

(72) Inventors: Michael A. Riley, Jacobus, PA (US); Jack Aspenson, Jasper, GA (US)

(21) Appl. No.: 18/199,309

(22) Filed: May 18, 2023

Related U.S. Application Data
(60) Provisional application No. 63/343,764, filed on May 19, 2022.

(51) Int. Cl. C04B 28/36; B29B 9/06; B29C 48/40; B29C 48/405; B29C 48/41

(52) U.S. Cl. CPC C04B 28/36; B29B 9/06; B29C 48/402; B29C 48/405; B29C 48/41

(57) ABSTRACT

The present invention provides a system for continuous production of sulfur polymer cement. The system may include a series of high shear mixers, such as twin screw mixers or compounding extruders, to which a sulfur-containing starting material is added at one end, followed by at least one stage at which a sulfur modifier is added. Micro-aggregate may be added at one or more stages. At the discharge end of the continuous system, an extrudate is produced, and a pelletizer may be used to form pellets of the polymerized sulfur and micro-aggregate material. The pelletizer may comprise a flowing cooled water system, e.g., underwater pelletizer. The formed pellets may then go through a dryer system and then to a dry storage collection system.

### CROSS-REFERENCE TO RELATED APPLICATION

This application claims the benefit of U.S. Provisional Patent Application No. 63/343,764 filed May 19, 2022, which is incorporated herein by reference.

### FIELD OF THE INVENTION

The present invention relates to methods for continuous production of sulfur polymer cement.

### BACKGROUND INFORMATION

Sulfur polymer cement and concrete has seen limited use over the past 40 years. This is primarily due to the fact that conventional methods for making such sulfur polymer cement involve batch processes that do not provide optimal efficiency for production or economic benefit.

### SUMMARY OF THE INVENTION

The present invention provides a system for continuous production of sulfur polymer cement. The system may include a series of high shear mixers, such as twin screw mixers or compounding extruders, to which a sulfur-containing starting material is added at one end, followed by at least one stage at which a sulfur modifier is added. Micro-aggregate may be added at one or more stages. At the discharge end of the continuous system, an extrudate is produced, and a pelletizer may be used to form pellets of the polymerized sulfur and micro-aggregate material. The pelletizer may comprise a flowing cooled water system, e.g., underwater pelletizer. The formed pellets may then go through a dryer system and then to a dry storage collection system.

An aspect of the present invention is to provide a method for continuous production of a sulfur polymer cement material comprising: introducing a sulfur-containing material into a continuous high shear mixer; introducing a sulfur modifier into the continuous high shear mixer; mixing the sulfur-containing material and the sulfur modifier together in the continuous high shear mixer to form a sulfur modified polymer; and extruding the sulfur modified polymer to produce an extrudate comprising the sulfur modified polymer.

This and other aspects of the present invention will be more apparent from the following description.

### BRIEF DESCRIPTION OF THE DRAWINGS

FIG. 1 is a partially schematic side view of a system for continuous production of sulfur polymer cement in accordance with an embodiment of the present invention.

FIG. 2 is a partially schematic side view of a portion of a twin screw mixer including intermeshing co-rotating screws.

FIG. 3 is a partially schematic side view of a portion of a twin screw mixer including intermeshing counter-rotating screws.

FIG. 4 is a partially schematic side view of a portion of a twin screw mixer including non-intermeshing counter-rotating screws.

FIG. 5 is a partially schematic isometric view of a portion of a ribbon extruder that may be used for continuous production of sulfur polymer cement in accordance with an embodiment of the present invention.

FIG. 6 is a partially schematic isometric view of a portion of a multiple-orifice extruder that may be used for continuous production of sulfur polymer cement in accordance with an embodiment of the present invention.

FIG. 7 is a partially schematic illustration of sulfur polymer cement pellets produced by a continuous production process of the present invention.

### DETAILED DESCRIPTION

A production process is provided in which sulfur-containing material may be polymerized in-situ using a continuous high shear mixer or extruder such as a twin-screw compounder/extruder or the like. As used herein, the term “high shear mixer” is a standard term known to those skilled in the art as meaning a mixer that dispenses or transports one phase or ingredient into another phase or ingredient using shear generated when one area of fluid travels with a different velocity relative to an adjacent area. High shear mixers typically use at least one rotating impeller or rotor to create flow and shear. Examples of high shear mixers include high shear reactors, twin screw extruders, rotor-stator mixers, high shear homogenizers and the like. The term “continuous”, when referring to high shear mixers, means that the materials to be mixed are drawn through the mixer from an inlet end to an outlet end, instead of batch-type mixers.

The mixing or extrusion process may be a continuous process that includes reactive extrusion compounding, which permits rapid formation of modified sulfur polymer due to a high degree of shear mixing and compounding possible from the extruder screw assembly, the temperature profile, and the raw materials selection. Unlike prior production of sulfur polymer and sulfur polymer cement, which rely upon long reaction times (several hours) of bulk polymerization between sulfur and its chemical modifiers, the present invention combines extruder shear mechanisms and temperature control with the addition of micro-aggregates and catalysts to create high shear tortuous path mixing conditions sufficient to cause the polymerization of sulfur with its chemical modifiers. The final product produced by the present process is a sulfur-polymer precursor/composite that is a thoroughly mixed blend of polymerized sulfur and micro-aggregate. The product may have characteristics and uses similar to concrete cement/mortar products, and can be considered a final product with desirable end-use properties. In addition, like cement, it can also be subsequently blended with macro-aggregate to product a sulfur-polymer concrete, just as conventional portland cement is blended with macro-aggregate to produce portland cement concrete.

Starting materials of the present process may include sulfur-containing material (liquid, prilled, powdered, pellets, pastilles, etc.), sulfur modifier, sulfur modifier catalyst (if required) and micro-aggregate (fly ash, slag, calcium carbonate, silica, clay, nano-fibers, graphenes, etc.), as more fully described below.

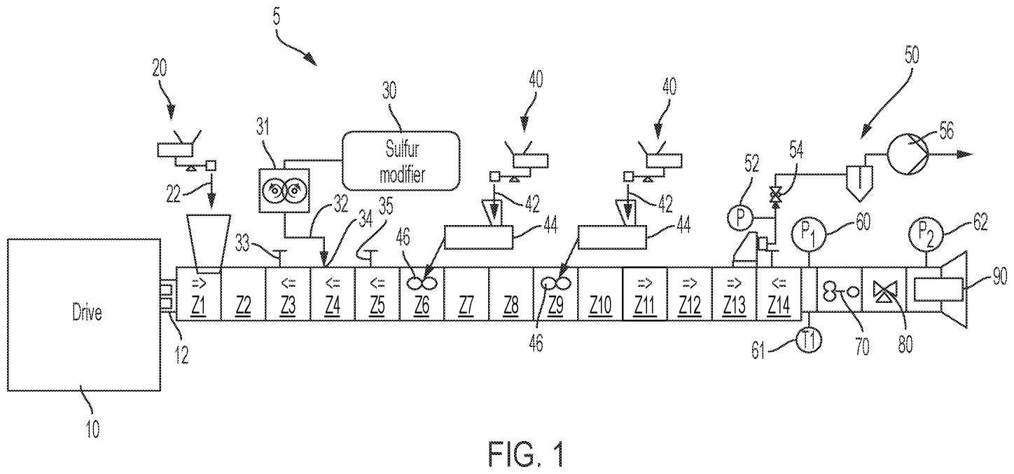

FIG. 1 is a partially schematic illustration of a system 5 for continuous production of sulfur polymer cement in accordance with an embodiment of the present invention. The continuous system 5 includes a drive 10 that selectively drives twin screw mixer driveshafts 12, and multiple mixing zones labeled Z1-Z14 in FIG. 1. Although fourteen mixing zones are shown, it is to be understood that any other suitable number of zones may be utilized.

The twin screw driveshafts 12 extend from the drive 10 into zone Z1, as shown in FIG. 1. The twin screws may be parallel or conical. Sulfur-containing material 22 may be fed into the first zone Z1 by a loss in weight feeder 20. As more fully described below, the sulfur-containing material 22 may be in any suitable form including pastilles, pellets, powder, liquid and the like. The sulfur-containing material 22 may flow from the feeder 20 into the first zone Z1 through a hopper. The rightward facing arrow in zone Z1 indicates that the sulfur-containing material 22 is fed toward the second zone Z2 by the twin screw mixer.

In the second zone Z2, the rotating shafts of the twin screw mixer 12 may be provided as smooth cylindrical shafts that have no screw threads or teeth.

Third, fourth and fifth mixing zones Z3, Z4 and Z5 are provided downstream from the sulfur-material introducing first zone Z1. In zones Z3-Z5, a source of sulfur modifier 30 may be selectively introduced into one or more of the mixing zones via a pump 31, such as a conventional peristaltic pump or the like. A sulfur modifier 32 may flow from the pump 31 into one or more of zones Z3, Z4 and Z5. Zone Z3 has an inlet port 33, zone Z4 has an inlet port 34, and zone Z5 has an inlet port 35. In the embodiment shown, the sulfur modifier 32 is introduced into the fourth zone Z4 via its inlet port 34. Alternatively, the sulfur modifier 32 may be introduced via the inlet port 33 into the third zone Z3 and/or via the inlet port 35 into the fifth zone Z5. Inside each of the zones Z3, Z4 and Z5, leftward facing directional arrows are shown, indicating that the sulfur modifier 32 may be introduced in the region of a counter-rotating screw of the twin screw mixer 12 in order to direct at least a portion of the sulfur modifier 32 in a direction counter to the rightward-flowing direction of the sulfur-containing material 22 in the first zone Z1. Such a directed flow pattern may increase the dwell time and shear rates of the combined sulfur-containing material 22 and sulfur modifier 32 in zones Z3-Z5 in order to achieve improved mixing and chemical reaction.

In the embodiment shown, the sixth zone Z6 and the ninth zone Z9 are regions where micro-aggregate in the form of flyash 42 is introduced into the system 5. A source of flyash may be fed to loss in weight feeders 40, and the flyash 42 flows into side-mounted twin screw injectors 44 that introduce the flyash into zones Z6 and Z9 through side inlet ports 46. In zones Z7, Z8 and Z10, the twin screw shafts may be smooth cylindrical shafts with no threads or teeth.

In zones Z11, Z12 and Z13, the initial sulfur-containing material and sulfur modifier have partially or fully reacted to produce a modified sulfur polymer which, along with the flyash used in this embodiment, travels in the direction of the rightward facing arrows. Zone Z14 may produce flow resistance as deposited by the leftward facing arrow against the rightward flow in zones Z11-Z13.

A pressure release system 50 is provided adjacent zones Z13 and Z14 to monitor and control pressure levels, and to avoid unwanted excessive buildup of pressure in the system 5. A pressure gauge 52 may monitor pressure in zone Z13 and/or zone Z14. A pressure release valve 54 is provided upstream from a pump 56 such as a vacuum pump. The pressure release system 50 may be used to control pressure levels and avoid excessive pressure buildup as the mixture passes through zones Z13 and Z14.

At the exit of zone Z14, a pressure gauge 60 and a temperature gauge 61 may be used to monitor the pressure and temperature of the mixture as it enters an accumulator 70, which builds up pressure of the modified sulfur polymer and micro-aggregate in order to exit the end plate die that determines its final physical form.

A valve system 80 may be provided downstream from the accumulator 70 in order to selectively allow the mixture to pass through into the pelletizing zone of the assembly or to exit the system 5, e.g., during start-up operations in which the characteristics of the mixture such as viscosity are stabilized before passing to the extrusion/pelletization stage. The valve assembly 80 may be of any suitable construction such as a three-way valve. The mixture is then fed to an extrusion die or pelletizer 90 which may be of any suitable configuration, as more fully described below.

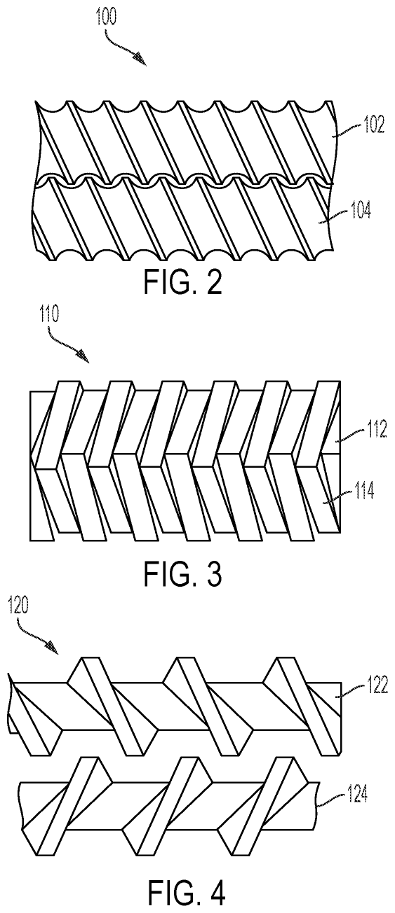

The screws of the twin screw drive shafts 12 may be selected to provide desired amounts of shear and mixing as the materials travel through the system 5. FIG. 2 schematically illustrates a portion of a twin screw mixer 100 including intermeshing co-rotating screws 102 and 104. FIG. 3 schematically illustrates a portion of a twin screw mixer 110 including intermeshing counter-rotating screws 112 and 114. FIG. 4 schematically illustrates a portion of a twin screw mixer 120 including non-intermeshing counter-rotating screws 122 and 124.

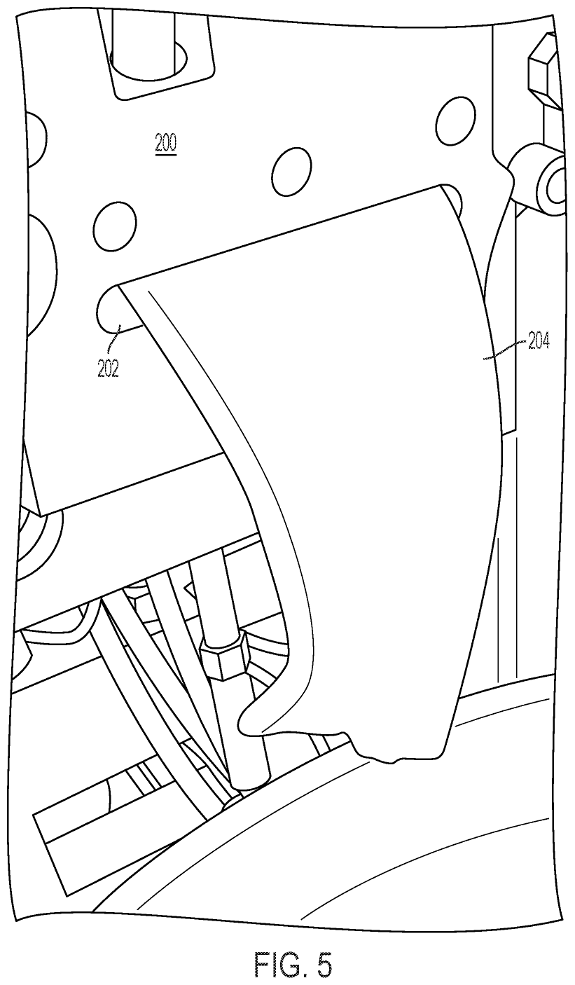

FIG. 5 schematically illustrates a portion of a ribbon extruder 200 with a ribbon extrusion die 202 that may be used for continuous production of extrudate comprising sulfur polymer cement 204 in accordance with an embodiment of the present invention.

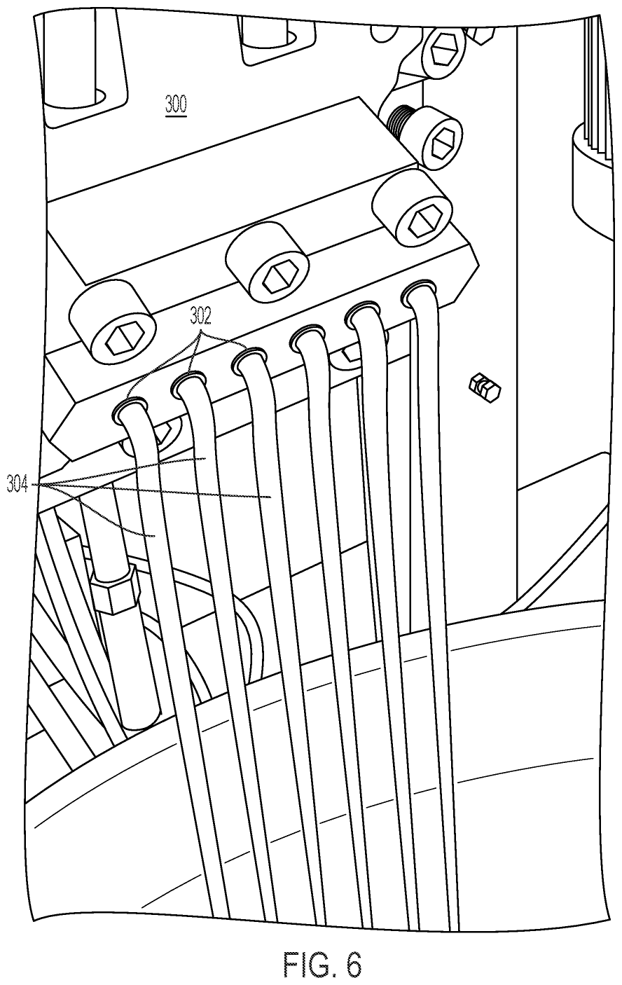

FIG. 6 schematically illustrates a portion of a multiple-step extruder 300 with a multiple-orifice extrusion die 302 that may be used for continuous production of extrudate comprising sulfur polymer cement 304 in accordance with an embodiment of the present invention.

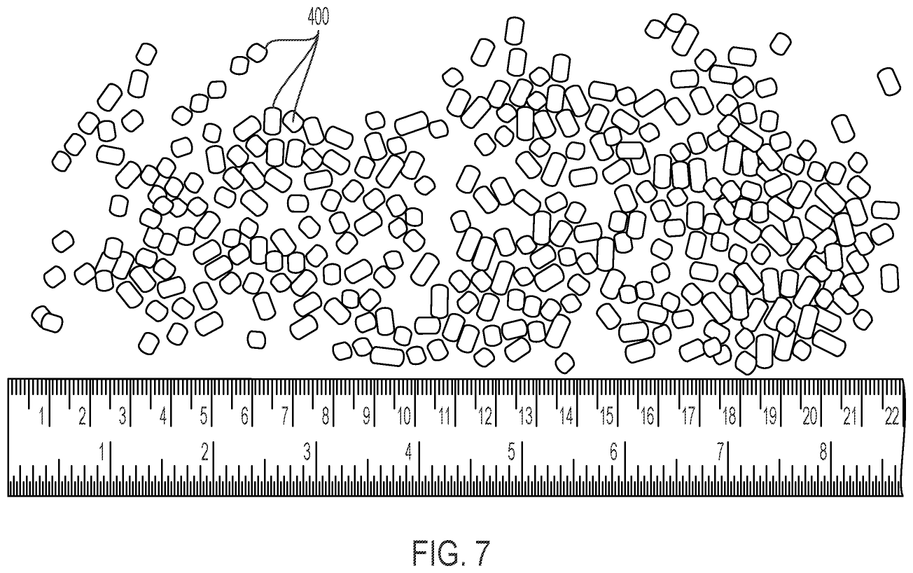

FIG. 7 schematically illustrates sulfur polymer cement pellets 400 that may be produced by a continuous production process of the present invention. The pellets 400 may be formed from the extrudate as it exits the system 5.

The extrusion process of the present invention permits the rapid polymerization of sulfur with a range of natural and synthetic modifiers that possess a high percentage of unsaturated hydrocarbons with double and triple carbon bonds, as more fully described below.

In some high speed production applications, sulfur modifier catalysts may be used. The reaction between sulfur and its modifiers may be accelerated through the addition of metal and metal oxide catalysts, as more fully described below.

The process may allow controlled introduction and thorough blending of micro-aggregates as part of a one-step mixing process. In accordance with an embodiment of the invention, the combination of high shear mixing and compounding achievable in a twin-screw extruder coupled with enhanced shear obtained with the addition of micro-aggregates permits the real-time polymerization of a stable sulfur polymer/sulfur polymer precursor/composite for either direct end use or the subsequent blending with macroaggregates to produce sulfur polymer concrete.

The sulfur-containing starting material may be provided in various forms including pellets, pastilles, powders, prills, liquid, or the like. As used herein, the term “sulfur-containing”, when referring to a starting material of the present process, means a material that is predominantly sulfur but may contain other constituents in lesser amounts. Sources of sulfur starting materials include crude oil, natural gas, mined rock sulfur, tar sands and the like. The sulfur-containing starting material may comprise more than 50 weight percent sulfur, typically at least 65 weight percent sulfur, for example, at least 75 weight percent, or at least 85 weight percent, or at least 90 weight percent, or at least 95 weight percent, or at least 98 weight percent.

The sulfur-containing starting material may typically comprise from 20 to 98 weight percent of the total weight of the starting materials, for example, from 22 to 50 weight percent, or from 25 to 35 weight percent.

The sulfur modifier may include dicyclopentadiene, D-limonene, alkenes, styrenes, plant triglycerides (linseed oil, soybean oil, corn oil, canola oil etc.), oleic acid, olefins, and the like. Sources of such sulfur modifiers may be cracking oils, seed oils, polymeric precursors, and the like. The sulfur modifier may typically comprise from 0.5 to 5 weight percent of the total weight of the starting materials, for example, from 1 to 4 weight percent, or from 1.5 to 2.5 weight percent.

Micro-aggregates including coal fly ash, bottom ash, municipal solid waste ash, ground blast furnace slag, micro-silica, nano-silica, calcium carbonate, clays, micro-fibers and nano-fibers (glass, basalt, carbon, cellulose), graphene/graphene oxide, and the like may be used. Aggregate to cement blend ratios ranging from 2 to 75 weight percent aggregate (aggregate/fiber combinations) are possible without impacting extruder performance or throughput. The micro-aggregate may typically comprise from 2 to 70 weight percent of the total weight of the starting materials, for example, from 20 to 50 weight percent, or from 30 to 45 weight percent. The micro-aggregate may typically have an average size of from 0.001 to 1 mm, for example, from 0.003 to 0.3 mm, or from 0.01 to 0.2 mm.

The sulfur modifier catalyst, when used, may typically comprise from 0.1 to 1.0 weight percent of the total weight of the starting materials, for example, from 0.25 to 0.75 weight percent, or from 0.3 to 0.5 weight percent. Examples of catalysts that may be adapted for use in the present invention are described in Wu et. al, “Catalytic inverse vulcanization”, Nature Communications 10:647 (2019), and U.S. Patent Application Publication No. US2021/0324147, both of which are incorporated herein by reference.

The optional sulfur modifier catalyst may be provided in the form of a stearate, thiuram or dithiocarbamate. Preferably, the catalyst is a dithiocarbamate. The catalyst may be a compound selected from one or more of zinc dithiocarbamate, zincdimethyldiothocarbamate, zinc diethyldiothiocarbamate, zincdipropylthiocarbamate, zinc dibutyldithiocarbamate or zinc dibenzyldithiocarbamate.

The sulfur starting material may be provided in liquid form or may be heated such that the sulfur is in molten form during the reaction. The sulfur may be pre-heated to the molten form before the catalyst and crosslinker are added. The catalyst may be added to the sulfur before or after the sulfur reaches the molten state. The organic crosslinker and/or modifier may be added to the sulfur before or after the sulfur reaches the molten state. For example, the catalyst may be added before sulfur reaches the molten state and the organic crosslinker is added after sulfur reaches the molten state. The organic crosslinker and catalyst should be distributed throughout the molten sulfur as the reaction progresses. Thus, during the process, the reaction mixture will typically be in a liquid form.

As the reaction progresses and crosslinks are formed between sulfur and the organic crosslinker(s), the molten reaction mixture may turn from liquid into a pre-polymer gel and then into a polymeric solid once fully crosslinked. The reaction mixture may turn from a liquid into a polymeric gel and stay in this form even when fully crosslinked.

The present process may be performed under controlled temperature conditions, for example, by heating to selected temperatures at various stages of the process. Heating may be achieved by any suitable means including conventional heating equipment such as electric, hot oil, or the like and/or passive frictional heating generated as the sulfur and other constituents pass through the zones of the high shear mixer(s). In certain embodiments, the reaction mixture may be cooled at various points of the process.

Suitable processing temperatures may typically range from 120 to 200° C., for example, from 130 to 190° C., or from 150 to 170° C. Compounding extruders may provide selected temperature control from zone to zone, each zone being only several inches in length. Zones may be controlled to within +/−0.5° C. The temperature ranges described above may vary along the length of the extruder shaft. For example, extruders may have from 10-20 zones and the temperature may be adjusted based on the specific action being performed in each zone. For example, the initial zones may be operated to quickly melt the sulfur if it is provided in solid form. These zones may ramp up from 150° C. to 170/180° C. rapidly to continuously melt the sulfur. At the end of the extruder, e.g., where a cold water chopper has been placed directly against the face of the extrusion die, a zone temperature of ˜200° C. may be maintained to counter the temperature loss from the cold water quench/chopping step. It will be understood by those skilled in the art that the particular temperatures and duration of heating will depend on the final application, volume of the product being continuously produced, and the desired properties of the sulfur-based polymer. For example, in an industrial setting, it may be advantageous to react the reaction mixture over a series of separate stages to increase efficiency or optimise the process. It may be advantageous in some cases to add organic crosslinker at different stages of the process to optimise the properties of the final polymer.

The product exiting the extruder can be collected as a continuous/discontinuous strand, a slab or pellets of a pre-selected size, e.g., as illustrated in FIGS. 5-7. The extrudate may be rapidly quenched, for example, using in-line water immersion, or air cooled on a chilled conveyor line if desired. The product may also be directly fed from a high shear extruder into a casting mold to produce net-shaped final products.

Pellets made by this process can also be dried and collected for remelt as-is, or by blending with a wide range of macro-aggregates using conventional heated mixers, such as those used to heat and blend asphalt. Such products constitute a sulfur-polymer concrete.

Articles produced by the final step may be in the form of a sulfur-based concrete-like composite with mechanical properties equal-to or greater-than those of other sulfur concrete products as well as those of conventional concrete. The sulfur polymer concrete produced from the continuously produced sulfur cement pellets/strands/slabs may be similar in other properties with conventional sulfur cement. The present invention provides a cost benefit of a continuously cast product with rapid polymerization.

The following examples are intended to illustrate various aspects of the present invention, and are not intended to limit the scope of the invention.

### Example 1

In this example, the twin screw-extruder used is a Coperion STS mc¹¹ compounder, but other twin-screw compounder systems and single-screw compounder systems may also be suitable for processing sulfur polymer compounding. The screw diameter of each of the twin screws was 35 mm.

Shaft speed. The shaft speed can be up to 900 rpm on the machine tested. In this example, the shaft speed was maintained at 850 rpm.

Zone heat profile. The extruder shaft may have anywhere from one to as many as 20 or more separately controlled temperature zones depending upon the extruder type selected. Each zone may be controlled to a very precise range of temperatures from ambient to 250C. In addition to the ability to control the thermal profile of the product being blended and compounded using zones heating, the shear of the polymer being extruded as it blends with other additives, including the sulfur modifier(s) and the micro-aggregates, also adds to the thermal profile of the product. Twin screw segmented design optimization may be achieved through the ability to change the flow and shear over increments as small as one inch along the screw shaft. In this example, the extruder used had 14 individual controlled temperature zones. Zones land 2 were maintained at 150° C. Zones 3-12 were maintained at 180° C. Zones 12-14 were heated to 200° C.

Raw materials may be dispensed in loss-in-weight or volumetric feeders that are controlled by the extruder. Sulfur-containing material (multiple grades ranging from 75-99.5% purity) is injected into zone 1 and heated to melt over 2 zones. Feed rate is adjustable through loss-in-weight (LIW)/volumetric feeders. The sulfur can be metered in as a dry powder, as a pre-melted liquid or as a partially pre-polymerized liquid (to increase the output production rate if desired).

Sulfur modifier/catalyst is injected in zone 3 at temp range from 150-170C. controlled by LIW feeder/pump. The modifier can be either a liquid or a solid.

Sulfur modifier catalysts (metal or metal oxide powders) may be injected into the extrusion line directly with the sulfur, with the modifier, or with the micro-aggregate. In its preferred embodiment, the longest dwell time of the catalyst with the molten components will insure the most complete polymerization of the sulfur.

Aggregates were injected in zones 6 and 9. Two injection points are chosen due to the high percentage of aggregates being accommodated by this process. Due to quantity (½ fed through each) a goal is not to overload the screw at a single injection point. The aggregates can be injected at other positions along the shaft axis, and can be injected in one or more feed points based on the volume of aggregate being added, the type of aggregate and the aggregate morphology. The aggregate feed rate is varied through the test from 25% to 70% by weight of the total product.

In this process, sulfur-containing material enters the extruder and melts to a relatively low viscosity, ˜7-10 centipoise. However, within a few seconds it comes into contact with a sulfur polymer modifier, which can be introduced either as a solid or as a liquid and then rapidly heated to the desired temperature range for polymerization. The modifier can also be preheated if desired to further accelerate the polymerization process. In addition, the modifier can at any point be combined with a polymerization catalyst to accelerate the speed of the polymer reaction. This blend, at its elevated temperature, has increased its viscosity to ˜90,000 centipoise. At this point, it is blended with micro and/or nanoaggregate at levels ranging from 2 to 75% of the final product weight. The viscosity has now been raised to several million centipoise and the shear reaction resulting in polymerization of the sulfur is complete. The twin-screw extruder has been designed to easily handle these ranges of viscosity.

Mixing may be controlled by selecting the optimum twin-screw design to accommodate compounding and blending throughout the entire length of the shaft, with variable temperature control at all zones. Twin-screw compounding extruders are designed to have variably adjustable screws. Depending upon the manufacturer, screw designs can be adjusted every 25-37 mm (1-1.5 inch) to create zones for rpaid forward flow, reverse flow, high shear, etc. The positioning of these individual screw segments to perform these different functions is critical to the final outcome of the product. In the experiment shown, the highest shear zones were designed to occur with the addition of the sulfur modifier with the molten sulfur, followed byt eh the addition of the micro-aggregate. In this sense, the screw function combines with the addition of the micro-aggregate to increase the localized shear on the sulfur polymer.

Extrudate may be generated in ribbon of multiple strand form. In conjunction with the extruded end-product die extrusion die orifice can then be coupled to high-speed rotational chopper. The chopper can be optimized to wet cut (underwater chopper) and rapidly quench the extrudate from an exit temperature at the die of 150-200C to ambient temperatures in seconds. Pellets formed ˜ can range in size from ⅛ inch diameter to over ½ inch diameter. Pellets are rapidly removed using a recyclable water bath through a high speed dryer and are collected as a dry pellet ready for post-processing. FIG. 5 illustrates sulfur-polymer composite extrudate in pellet form with 65% micro-aggregate.

Extrudate production speed may be variable from 50->50,000 lbs. per hour, depending upon the capacity required. Higher outputs may require larger twin screw extruders with larger diameter twin screws. In this example, the processing speed was 650 lbs/hr (˜295 kg/hr)

The resulting end product(s) may exhibit the following characteristics: extrudate is waterproof in pellet form and can be easily stored and conveyed in supersack, tank truck, silo, etc.; cast product made from these pellets have the ability to be removed from a mold (final set with sufficient mechanical strength) in as little as one hour; and cast product cures to its final ultimate mechanical properties within 24 hours. Based on the selection of aggregates and cement/aggregate ratios, compressive strengths as high as 10,000 psi (˜68 MPa) can be achieved within 24 hours after casting. In this example, the sulfur polymer concrete consisted of the following materials and weight percentages: sulfur polymer—10 (made from sulfur with purity of 98%); Class F fly ash—15; ASTM C-33 grade sand—37.5; ⅜ inch granite aggregate—37.5; 2 hr compressive strength: 4520 psi; 24 hr compressive strength: 8475 psi.

### Example 2

Using the same mix conditions described in Example 1, tests were conducted with reduced purity sulfur-containing material. The specific contaminant for this test was diatomaceous earth and the percentage of thus composite material was 85% sulfur, 15% diatomaceous earth. Taking into account the 15% diatomaceous earth as a portion of the micro-aggregate, the formula for the mix was: Sulfur polymer—10%; diatomaceous earth—5%; class F fly ash—10%; ASTM C-33 grade sand—37.5%; ⅜ inch granite aggregate—37.5%.

The resulting sulfur polymer concrete has the following compressive strengths: 2 hr compressive strength—2800 psi; 24 hr compressive strength—6225 psi.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. A method for continuous production of a sulfur polymer cement material comprising:
introducing a sulfur-containing material into a continuous high shear mixer;
introducing a sulfur modifier into the continuous high shear mixer;
mixing the sulfur-containing material and the sulfur modifier together in the continuous high shear mixer to form a sulfur modified polymer; and
extruding the sulfur modified polymer to produce an extrudate comprising the sulfur modified polymer.

2. The method of claim 1, wherein the sulfur modifier is introduced into the continuous high shear mixer downstream from the sulfur-containing material.

3. The method of claim 1, further comprising:
introducing micro-aggregate into the continuous high shear rate mixer; and
mixing the micro-aggregate with the sulfur modified polymer in the continuous high shear rate mixer prior to the extruding step.

4. The method of claim 3, wherein the sulfur-containing material comprises from 20 to 98 weight percent of the total weight of the sulfur-containing material, sulfur modifier and micro-aggregate.

5. The method of claim 1, wherein the sulfur-containing material is in the form of pellets, pastilles, powder, prills, liquid or a combination thereof.

6. The method of claim 1, wherein the sulfur-containing material comprises at least 65 weight percent sulfur.

7. The method of claim 3, wherein the sulfur modifier comprises from 0.5 to 5 weight percent of the total weight of the sulfur-containing material, sulfur modifier and micro-aggregate.

8. The method of claim 1, wherein the sulfur modifier comprises dicyclopentadiene, D-limonene, alkenes, styrenes, plant triglycerides, oleic acid, olefins, and combinations thereof.

9. The method of claim 3, wherein the micro-aggregate comprises coal fly ash, bottom ash, municipal solid waste ash, ground blast furnace slag, micro-silica, nano-silica, calcium carbonate, clays, micro-fibers and nano-fibers, or a combination thereof.

10. The method of claim 3, wherein the micro-aggregate has an average particle size of less than 1 mm.

11. The method of claim 1, further comprising introducing a sulfur modifier catalyst into the continuous high shear mixer.

12. The method of claim 11, wherein the sulfur modifier catalyst comprises a stearate, thiuram, dithiocarbamate, or a combination thereof.

13. The method of claim 1, further comprising pelletizing the extrudate.

14. The method of claim 13, further comprising cooling the extrudate during the pelletizing step.

15. The method of claim 14, wherein the pelletizing is performed in a cooled water system.

16. The method of claim 13, further comprising drying the pelletized extrudate.

17. The method of claim 1, further comprising heating the sulfur-containing material and the sulfur modifier in the continuous high shear mixer.

18. The method of claim 17, wherein the heating is performed at a temperature of from 120 to 200° C.

19. The method of claim 1, wherein the continuous high shear mixer comprises a twin screw compounding extruder.

20. The method of claim 19, wherein the twin screw compounding extruder comprises co-rotating screws and/or counter-rotating screws, and the co-rotating or counter-rotating screws are intermeshing or non-intermeshing.

21. The method of claim 20, wherein the twin screws are parallel or conical.
